(19) United States
(12) Patent Application Publication
(10) Pub. No.: US 2025/0135378 A1
(43) Pub. Date: May 1, 2025

(54) SELF-CLEANING FILTRATION SYSTEM WITH MINIMAL WASTE GENERATION FOR WATER PURIFICATION APPLICATIONS

(71) Applicant: Halldor Systems, LLC, Lantana, TX (US)

(72) Inventors: Brent Halldorson, Lantana, TX (US); James McMillan, Fort Worth, TX (US); Jack McMillan, Fort Worth, TX (US); Erik Halldorson, Lantana, TX (US)

(73) Assignee: Halldor Systems, LLC, Lantana, TX (US)

(21) Appl. No.: 18/921,152

(22) Filed: Oct. 21, 2024

Related U.S. Application Data
(60) Provisional application No. 63/593,719, filed on Oct. 27, 2023.

(51) Int. Cl. B01D 29/68; B01D 29/33; B01D 29/52; B01D 35/16; C02F 1/00

(52) U.S. Cl. CPC B01D 29/682; B01D 29/33; B01D 29/52; B01D 35/16; C02F 1/004; B01D 2201/084; B01D 2201/16; C02F 2303/16

(57) ABSTRACT

A water filtration system is shown which uses a number of rigid tubular screen type filter elements having porous exterior and interior sidewalls. The interior sidewalls form an initially open interior axial bore. The filter elements are closed at a bottom end thereof and open at a top end thereof. An elongated spray bar is rotatably mounted for rapid rotation within the open interior axial bore of each of the tubular filter elements. The spray bar has a plurality of slots cut along the length thereof in a predetermined pattern and an internal bore which is in communication with a source of high-pressure air and high-pressure water. The application of high-pressure air or water provides a brief pressure pulse directed radially outward which causes the spray bar to rotate and spray air or water outwardly from the spay bar slots and through the interior sidewall of the porous filter elements to dislodge any collected filter cake from the exterior wall surfaces in use.

### BACKGROUND OF THE INVENTION

### 1. Cross Reference to Related Applications

This case claims priority from a previously filed provisional application Ser. No. 63/593,719, filed Oct. 27, 2023, entitled “Self-Cleaning Filtration System With Minimal Waste Generation For Water Purification Applications,” by the same inventors.

### 2. Field of the Invention

The present invention relates generally to industrial water treatment/purification systems, such as the solid/liquid separation systems used to treat the produced water stream derived from an oil or gas recovery operation, or other wastewater streams and, more specifically, to a self-cleaning filter apparatus for use in such a system employing repeatedly re-cleanable and reusable filter elements.

### 3. Description of the Prior Art

It is well known that the wastewater or produced water from oil and gas recovery operations has relatively high concentrations of contaminants including various organics, silica, boron, suspended and dissolved solids such as dirt and sand, etc. If such wastewater or produced water is to be discharged re-used in frac stimulation applications or sent to long term pit storage, it must be filtered to assure low turbidity (suspended solids), low iron and is often treated with an oxidant to provide a high oxygen reduction potential (ORP), thereby limiting bacteria growth.

In the past, various expensive and highly technical processes have been used for treating such produced water and wastewater including ion exchange processes, reverse osmosis processes and the use of other type membrane filtration processes. The equipment for these processes was very expensive and maintaining the equipment involved a number of complications. For example, in the case of feed water produced by oil and gas operations, the recovery across reverse osmosis systems was often limited by scaling due to silica or fouling due to organics. High concentrations of silica in the feed water had a tendency to scale the reverse osmosis membranes due to the concentration of silica exceeding solubility limits. Organics that exceed solubility limits also 6 tended to foul the reverse osmosis membranes. Scaling due to silica and fouling due to organics can cause substantial down time of the reverse osmosis unit or units, requiring frequent cleaning, replacement and maintenance. The maintenance is obviously expensive and the down time is costly and inefficient.

In addition to reverse osmosis, other water treatment/purification treatment systems included such technologies as thermal distillation, high pH clarification, electro-coagulation and oxidant flocculation. The costs per barrel of treated water for these type systems varied from about $1.50-$3.00/barrel for a distillation process to about $0.30/barrel in the case of oxidant flocculation. However, present trends in the oil and gas industry are moving away from these complex and exotic technologies, toward simplicity and lower cost. In the present well operating environment, there are many instances where a simpler, more economical system might be used. One example would be in the case of “on-the-fly” processes, where the well frac water is treated and then immediately reused (no long-term storage).

Despite the need for a system to fill this niche, existing commercial systems have suffered from various deficiencies. For example, in the case of “absolute” filtration systems, key issues have existed with regard to low overall capacity, high cost, and the fact that the screens used are prone to screen/nozzle plugging, as well as very high backwash requirements. Even in the case of “non absolute” filtration systems, such as “WSF Media Bed Filtration,” problems have existed with regard to solids “break-through” in the media bed, leading to poor performance as well as low capacity and high cost. In the case of disc filters, problems have existed with regard to solids “break-through” of the disc grooves. Only a single point of failure is a major problem and system performance in all of these type filtration systems tends to get worse over time with wear.

The present invention aims to overcome many of the above noted deficiencies in the prior art by providing a simple and economical water treatment/purification system which uses more economical mesh screen filter elements in an air/water operating cycle which provides repeatably re-cleanable and reusable filter elements, as will be described more fully in the written description which follows. Using a simpler system of this type might lower the treatment cost for produced water, for example, to less than 25% of current flocculation (i.e., DAF, clarifer) solids removal systems, while achieving a throughput of as much as 50K+ barrels of water produced daily.

### SUMMARY OF THE INVENTION

The present invention thus relates to a system for treating industrial wastewater streams, such as the produced water stream derived from an oil or gas recovery operation, and particularly to an improved filter element for use in such systems. The improved filter element of the invention is used in a filtration vessel which filters water containing suspended solids, i.e., contaminants and debris. The improved filter element is formed as a rigid tubular screen type filter element having porous exterior and interior sidewalls, the interior sidewalls forming initially open interior axial 8 bores. Each of the filter elements has a closed bottom end and an open top. A plurality of filter elements are mounted within the filter vessel or canister. More than one vessel may be used in tandem, so that continued filtration is always provided, even during purge cycles.

An elongated spray/purge bar is rotatably mounted for rapid rotation within the open interior axial bore of each of the tubular filter elements. The spray bar has a plurality of slots cut along the length thereof in a predetermined pattern. The spray bar has an internal bore which is in communication with a source of high-pressure air and high-pressure water for providing a brief pressure pulse of high-pressure air or water radially outward which causes the spray bar to rotate and spray air or water outwardly from the spay bar slots and through the interior sidewall of the porous filter elements to dislodge the collected cake from the exterior wall surfaces in use. Spraying from the inside-out also blasts debris from adjacent filter elements within the vessel. Because the spray/purge bar is located on the inside of the filter element, it is only exposed to the “clean”, filtered water passing through the system and no to the high-solids water which could otherwise plug the spray bar slots.

The pattern of slots which extends along the length of the spray bar is arranged in a predetermined, indexed fashion so as to cause the spray bar to rotate when pressurized, without the use of any mechanical drive mechanism. The slots are cut in a tangential, offset manner to cause this spinning action when the spray bar is pressurized. The spray bar has a top and bottom oppositely arranged extents and wherein the top extent is designed to be received within a bushing located in an opening provided in an upper tube sheet of the filtration vessel, the bushing allowing rotational movement of the spray bar at the top extent thereof. The spray bar bottom extent is designed to be received on a bearing cup to provide support for the lower extent of the spray bar. The bearing cup is preferably made of a durable synthetic material such as, for example, HDPE. In the most preferred arrangement, the spray bar lower extent rides on a ball bearing within the synthetic bearing cup in use. The upper extent of the spray bar is connected by suitable fluid tubing to a high-pressure air and high-pressure water source

In its preferred form, the improved tubular filter element of the invention is designed to be used in a self-cleaning rigid screen type water filtration system for treating water containing solids, where the system is comprised of:
a generally cylindrical filter vessel having a vessel interior which houses an elongated filter array comprising a plurality of rigid tubular screen type filter elements each having porous exterior and interior sidewalls, the interior sidewalls forming interior axial bores, the filter elements being closed at a bottom end thereof and open at a top end thereof;
an unfiltered water inlet to the vessel for providing a feed stream of slurry water containing solids to be filtered;
wherein the unfiltered water is received in a bottom region of the vessel interior and travels upwardly through the interior of the vessel, the unfiltered water contacting the exterior sidewalls of the filter elements at a sufficient pressure so that the fluid of the slurry passes inwardly through the sidewalls of the tubular filter elements, with a majority of the solids within the slurry being collected as a cake on the exterior sidewalls, without substantial intrusion into the interior axial bore of the filter elements;
an elongated spray bar is rotatably mounted for rapid rotation within each of the filter elements, each of the spray bars having a plurality of slots cut along the length thereof in a predetermined axially offset pattern, the spray bars having an internal bore which is in communication with a source of high pressure air and high pressure water for providing a brief pressure pulse of high-pressure air or water radially outward which causes the spray bar to rotate and spray air or water outwardly from the spay bar slots and through the interior sidewalls of the porous filter elements to dislodge any collected cake from the exterior wall surfaces.

The fluid inlet and outlet to and from the vessel communicate with a pressure source, through suitable valving for reversing the flow of fluid though the interior of the vessel and recirculating filtered slurry through the sidewalls of the filter elements to dislodge a portion of the cake and to control the thickness thereof in a backwash operation. Because of the arrangement of component parts and steps in the filtration operation of the invention, the percent backwash required is generally less than 1 percent as compared to 20 plus percent for conventional self-cleaning filters.

In the preferred system of the invention, the filter array comprises a plurality of generally parallel filter tubes having open upper ends and closed lower ends, an upper plate interconnecting the upper ends of the tubular filter elements so that the bores thereof open upwardly of the upper plate into a top chamber, and a lower plate interconnecting the closed lower ends thereof and forming part of a bottom chamber, the system including a shell enclosing the array to form a filtrate chamber about the tubular filter elements between the upper and lower plates, the fluid outlet being in fluid communication with the top chamber. A discharge outlet located at the extreme bottom region of the vessel includes a normally closed valve for opening and closing off the discharge of sludge buildup in the vessel interior.

The improved filter elements of the invention can be used in a filtration process which includes the steps of:
providing an inlet stream of a solid/fluid feed slurry to be filtered;
feeding the slurry into simultaneous engagement with the exterior porous sidewalls of each of a plurality of rigid screen type tubular filter elements at a pressure sufficient to attain surface filtration by the porous sidewalls of the filter elements, so that fluid of the slurry passes upwardly through the interior of the tubular filter elements and solids within the slurry are collected on the exterior sidewall surfaces of the porous filter elements;
controlling the axial velocity of the feed slurry into the filter elements to form a controlled filter cake of solids on the porous exterior sidewalls of the tubular filter elements whereby the controlled filter cake of solids acts as an auxiliary filter for the process, including regulating the radial flow velocity of the fluid and the radial differential pressure across the filter.

Additional objects, features and advantages will be apparent in the written description which follows.

### BRIEF DESCRIPTION OF THE DRAWINGS

FIG. 1 is a schematic view of the flow of a solid's containing fluid through a filter vessel of the invention;

FIG. 2 is a partially broken away view of the top plate of the filtration chamber of the vessel of FIG. 1 showing the filter tube retainer support and the bearing support for the upper end of the internal spray bar used to repeatedly re-clean the filter elements;

FIG. 3 is a simplified view of the bottom plate of the filter vessel of FIG. 1;

FIG. 4 is a side view, partially in section, of a rigid screen type filter element used in the filter vessel of FIG. 1, showing the internal, rotatable spray bar used in the cleaning process;

FIG. 4A is a top view of the filter element of FIG. 4, showing the high-pressure water and air input for the spray bar which is located in the interior of the filter element;

FIG. 5 is a perspective view of the exterior of one of the filter elements used in the system of the invention;

FIG. 5a is a bottom view of the filter element of FIG. 5, showing the closed, bottom end of the filter element and showing the retaining pin which extends from the bottom of the filter element which is used to mount the filter element in the interior of the filter vessel;

FIG. 6 is a side, cross-sectional view of the filter element of FIG. 5, showing the internal spray bar and a reinforcing coil arrangement;

FIG. 6A is a top view of the filter element of FIG. 6, showing the opening in the top of the filter element;

FIG. 7 is a perspective view of the spray bar which is rotatably mounted in the interior of the filter elements of the invention, showing the discharge slots which are spaced tangentially along the length of the spray bar, the slots being indexed around the outer diameter of the spray bar in a manner which causes the spray bar to rotate when the interior of the bar is pressurized;

FIG. 8 is another perspective view of the spray bar used in the filter elements of the invention, showing the spacing and indexing of the discharge slots with the bar rotated slightly from the position of FIG. 7; and

FIG. 9 is another partly schematic view of one of the spray bars used in the filter elements of the invention shown from different rotational positions.

### DETAILED DESCRIPTION OF THE INVENTION

The preferred version of the invention presented in the following written description and the various features and advantageous details thereof are explained more fully with reference to the non-limiting examples included and as detailed in the description which follows. Descriptions of well-known components and processes and manufacturing techniques are omitted so as to not unnecessarily obscure the principal features of the invention as described herein. The examples used in the description which follows are intended merely to facilitate an understanding of ways in which the invention may be practiced and to further enable those skilled in the art to practice the invention. Accordingly, the examples should not be construed as limiting the scope of the claimed invention.

The present water filtration system can be used in a variety of wastewater treatment processes. One of the most common examples is for use in treating “produced water” from oil and gas well bore operations. This “produced water” is highly variable in composition and typically a brine solution which contains organics, silica, boron, dissolved solids and suspended solids. Such water is produced along with oil or gas in an oil or gas recovery process. Typically, the oil or gas is separated from the water and the separated water is referred to as “produced water” which is one type of wastewater. The present invention presents a process that can be utilized to treat this type of wastewater, but is not limited to “produced water” and can be used in various types and forms of wastewater treatments. Thus, while one of the primary initial markets for the invention will be oilfield produced water, it is understood that the same needs being addressed (high variability input, oily/sticky solids, corrosive brine environment) also exist in multiple other non-oilfield areas (industrial, mining, waste processing, manufacturing, food and beverage industry, etc.).

In its simplest form, the filtration system of the invention includes a plurality of novel tubular rigid screen type filter elements which are housed in a filter vessel or canister. A feed stream of a separable solid/fluid slurry flows into the bottom of the filter vessel which houses the array of vertical tubular filter elements that are closed at their bottom ends. The slurry comes into contact with the exterior surface of the tubular filter elements, causing the solid material to be retained on the exterior of the filter elements, while the liquid or fluid passes through the sidewalls of the filter elements into the interior of the tubes and subsequently out the top of the filter housing. The filtered solids restrained by the sidewalls of the filter elements form a loose cake on the exterior of the filter elements. The filter cake actually acts as a sort of “auxiliary filter” in the normal operation of the system of the invention because the filter elements are intentionally “run dirty.”

The filter system typically uses a low fluid approach velocity so as not only to provide a surface filtration effect with restricted filter intrusion but also to permit a pulsed backflow radially through the filter elements to remove the filtered solids on the exterior of the filter elements. When an element becomes plugged as evidenced by a given backpressure being observed, the system is put into a purge cycle which reverses flow through the unit so that a sudden pulse forces filtrate through the walls of the filter elements to “blow” or dislodge the cake from the exterior of the filter surfaces. The novel spray bar arrangement in the interior of each filter element can then be used to spray high pressure air or high-pressure water to further clean the filter elements, as will be described in greater detail. The dislodged solids can then be drawn from the bottom of the filter vessel and thereafter the filtration process can be restarted.

The system of the invention may thus be described as an “outside-in” system where an outside-in flow path is provided for the feed slurry through each of the tubular porous filter elements within the filter tube array. The feed slurry typically has fine solid particulate material dispersed throughout and carried within a fluid medium. This slurry preferably is brought into fluid engagement with the exterior porous sidewalls of the tubular filter elements so that the fluid portion of the slurry readily passes through the cylindrical walls of the filter media along an “outside-in” flow path while the solid materials are collected on the porous exterior sidewalls of the tubular filter elements.

As briefly described, the filtered solids are periodically cleaned off to rejuvenate or “self-clean” the filter. This is achieved by a backflow or “inside-out” pulse of fluid radially through the porous walls of the filter tubes to dislodge or jolt the solids free from the exterior sidewalls and sweep them axially toward a discharge area. The backflow pulse tends to blow or dislodge the collected solids from the exterior surfaces while the rapid axial spray flushing can provide a scrubbing effect that removes the particles from the walls and directs them towards the center of the axially moving discharge stream. This action can be followed by the previously described rapid axial spray flushing of the interior bores of the filter tube elements. The need to periodically clean the filter elements can be determined by measuring the pressure drop across the filter elements and triggering the cleaning action at a preselected differential pressure level.

Various materials may be used to construct the filter tubes used in the system of the invention. The sidewalls of the filer tubes are composed of a filter media of controlled porosity and permeability. The porous filter elements can be manufactured using a variety of commercial process, including the procedure commonly referred to as a sintering process. In this type process, a controlled porosity material is obtained by the consolidation of a metal powder into a porous aggregate. The sintering process is carried out at temperatures approaching the melting point of the particular alloy being manufactured, and in a controlled atmosphere. One example of an acceptable filter for producing cleanable, re-useable filters is a rigid mesh screen formed of stainless steel. Other acceptable materials such as copper, nickel, Monel, Inconel, Hastelloy as well as other metals or alloys may also be utilized. The screen mesh size can vary depending upon the application at hand. For example, for the produced water applications under consideration typical mesh sizes are in the 20-50 micron range. For other applications, the mesh range may vary from <10 micron to >200 micron.

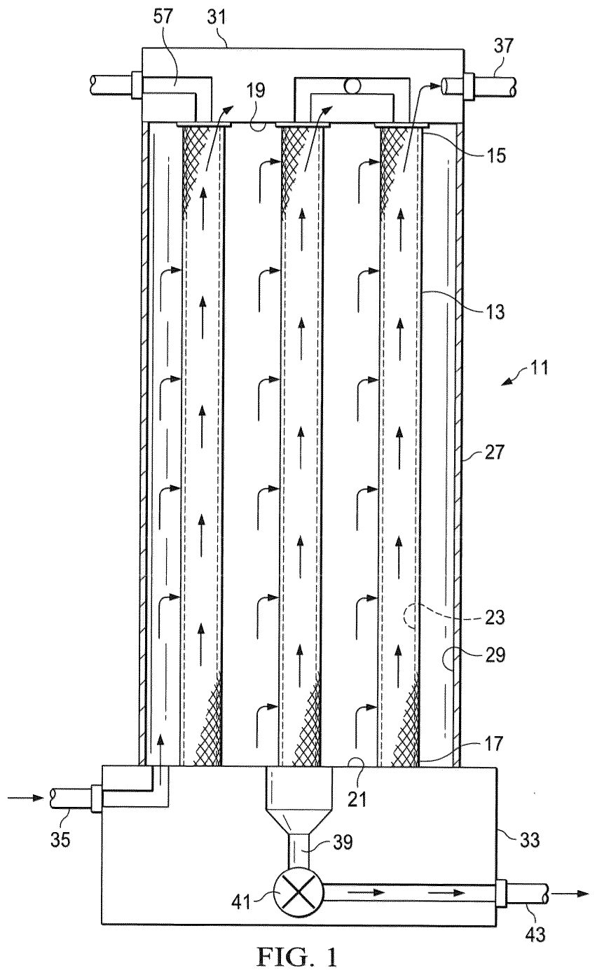

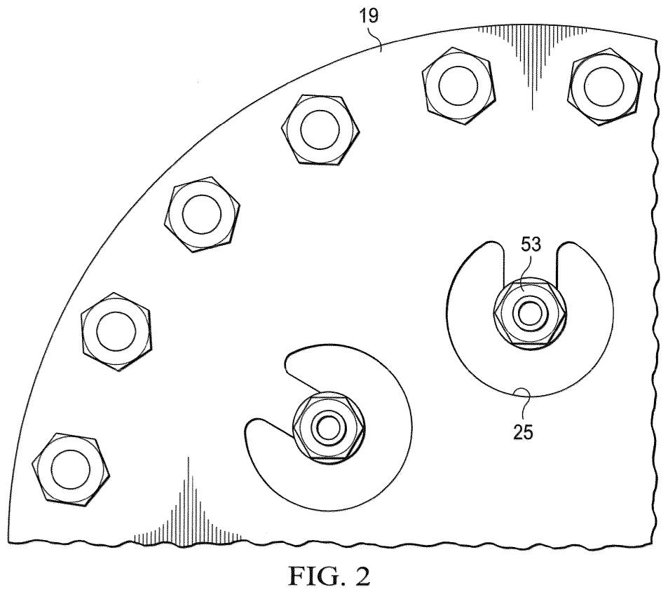

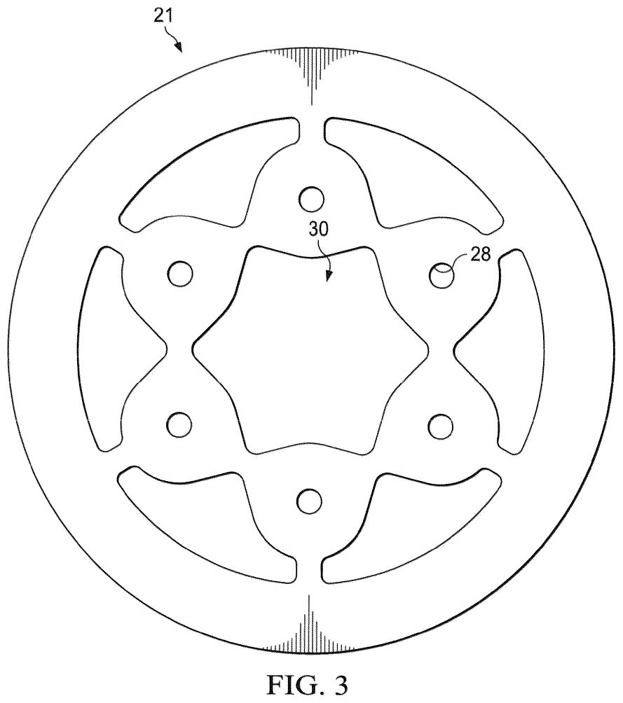

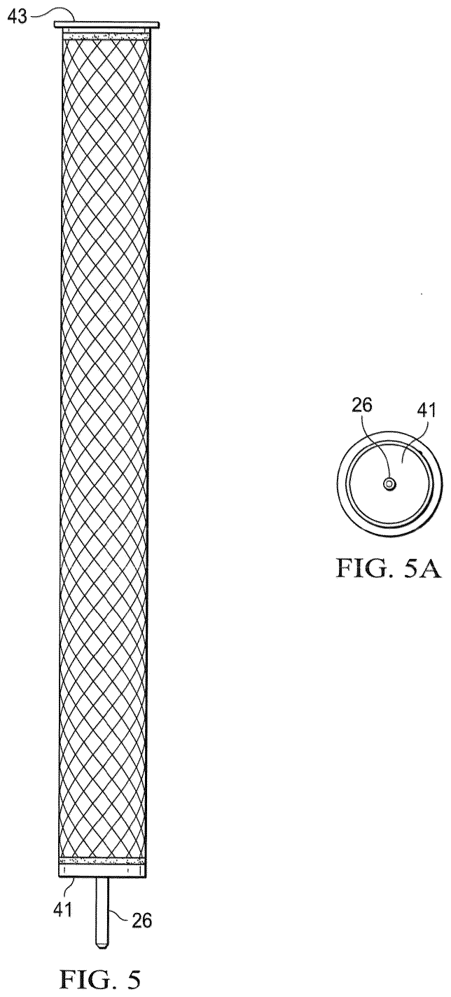

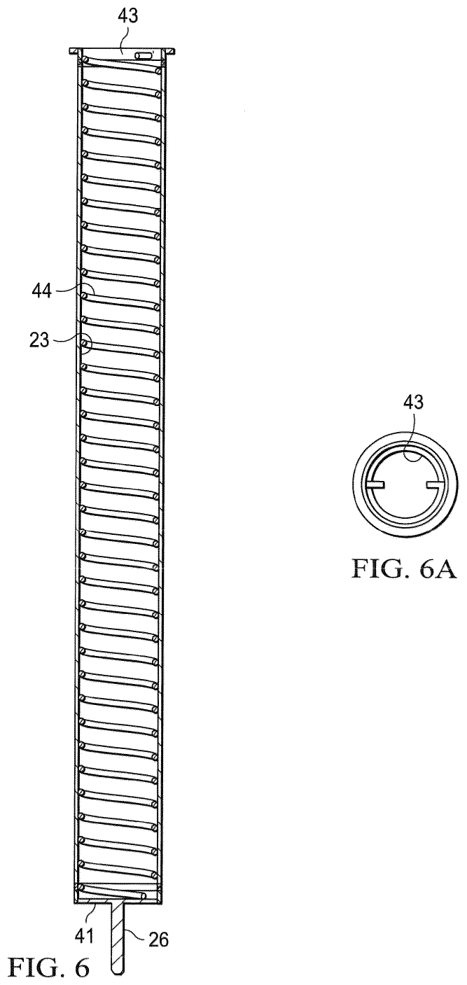

Turning now to the drawings and particularly to FIG. 1, there is shown a simplified, partly schematic view of a filter vessel, designated as 11, employing a plurality of the improved filter elements of the invention 13. The assembly or array is mounted within a suitable housing. Each filter tube 13 is open at the top end 15 and closed at the bottom end 17. The vessel has an upper and lower tube sheets 19, 21, with the filter elements being sandwiched in between. Each filter tube has a cylindrical wall with an inner surface forming an interior axial bore 23. The upper or top end 15 of each filter tube 13 is securely mounted within apertures 25 (FIG. 2) provided in the upper tube sheet 19. Similarly, the lower end 17 of each filter tube 13 is securely mounted by means of a downwardly extended pin (e.g., 26 in FIGS. 5 and 6) within a receptacle (such as opening 28 in FIG. 3) provided in the lower tube sheet 21. The openings 28 in the lower tube sheet are used to center the “pin” 26 of each filter element while the open area 30 allows dirty water to flow inside the filter tube bundle, as well as to allow the purge of waste to flow back out. The filter tubes 13 are oriented generally parallel to each other and rigidly interconnected by the tube sheet plates 19, 21, to form a rigid filter assembly.

The filter assembly is mounted within a cylindrical shell 27 (FIG. 1). The shell 27 extends between the upper tube sheet 19 and the lower tube sheet 21 so as to form a central fluid chamber 29 about and between the exterior of the filter tubes 13. As seen in FIG. 1, an upper fluid chamber 31 is formed above the upper tube sheet 19, which chamber communicating with open ends 15 of the tubes 13. Similarly, the lower tube sheet 21 forms the top wall of a lower fluid chamber 33 where fluid to be treated is introduced through a fluid inlet 35. As shown by the arrows in FIG. 1, the fluid to be filtered flows with the vessel interior 29 and through the sidewalls of the filter elements, up the interior of the elements, and then exits at the top openings 15 of the elements. It then passes out a fluid outlet 37.

The bottom chamber 33 has an internal passageway 39 leading to a discharge valve 41 and a sludge outlet 43 for draining sludge from the vessel interior. The normally closed discharge valve 41 controls the opening and closing of the discharge outlet 43.

As has been mentioned, the fluid inlet 35 and outlet 37 to and from the vessel communicate with a pressure source (not shown), through suitable valving for reversing the flow of fluid though the interior 29 of the vessel and recirculating filtered slurry through the sidewalls of the filter elements to dislodge a portion of the cake and to control the thickness thereof in a backwash operation.

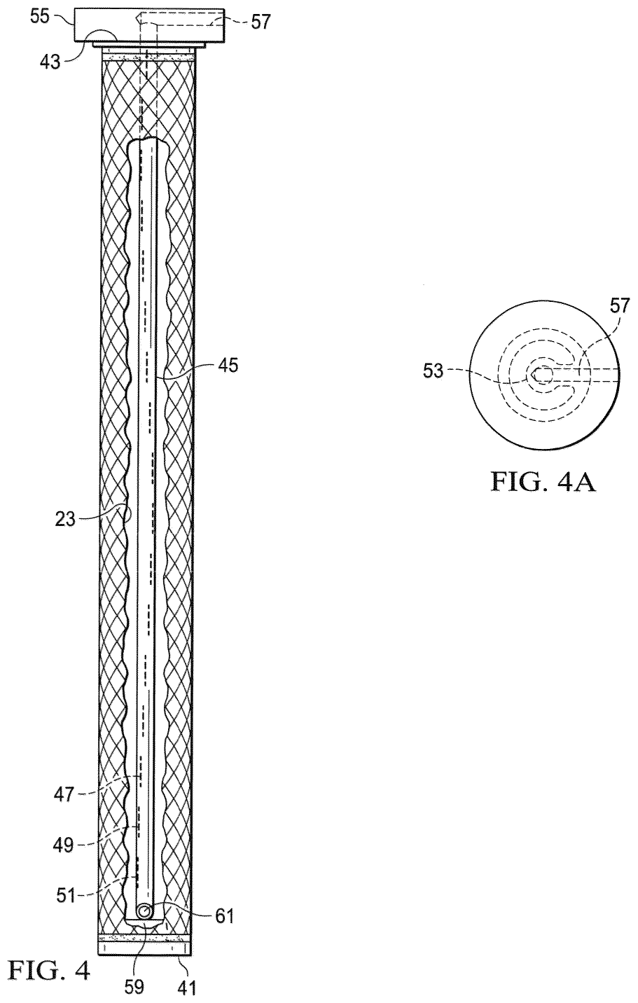

The improved filter elements of the invention are shown in greater detail in FIGS. 4-6. As will be appreciated from these figures, each filter element is a rigid tubular screen type filter element having porous exterior and interior sidewalls, the interior sidewalls forming initially open interior axial bores (39 in FIGS. 1, 4 and 6). Each filter element has a closed at a bottom end 41 thereof and is open at a top end 43 thereof. In the example illustrated, each of the filter elements is reinforced internally by an elongated coil spring (44 in FIG. 6).

An elongated spray/purge bar 45 is rotatably mounted for rapid rotation within the open interior axial bore 23 of each of the tubular filter elements 13. As will be appreciated from FIGS. 4-9, the spray bar 45 has a plurality of slots (such as slots 47, 49, 51) cut along the length thereof in a predetermined pattern. The spray bar has an internal bore 53 (FIG. 9) which is in communication with a source of high-pressure air and high-pressure water (not shown) for providing a brief pressure pulse of high-pressure air or water radially outwardly from the slots, which causes the spray bar 45 to rotate at high speed and spray air or water outwardly from the spay bar slots through the interior sidewall of the porous filter elements to dislodge the collected filter cake from the exterior wall surfaces in use.

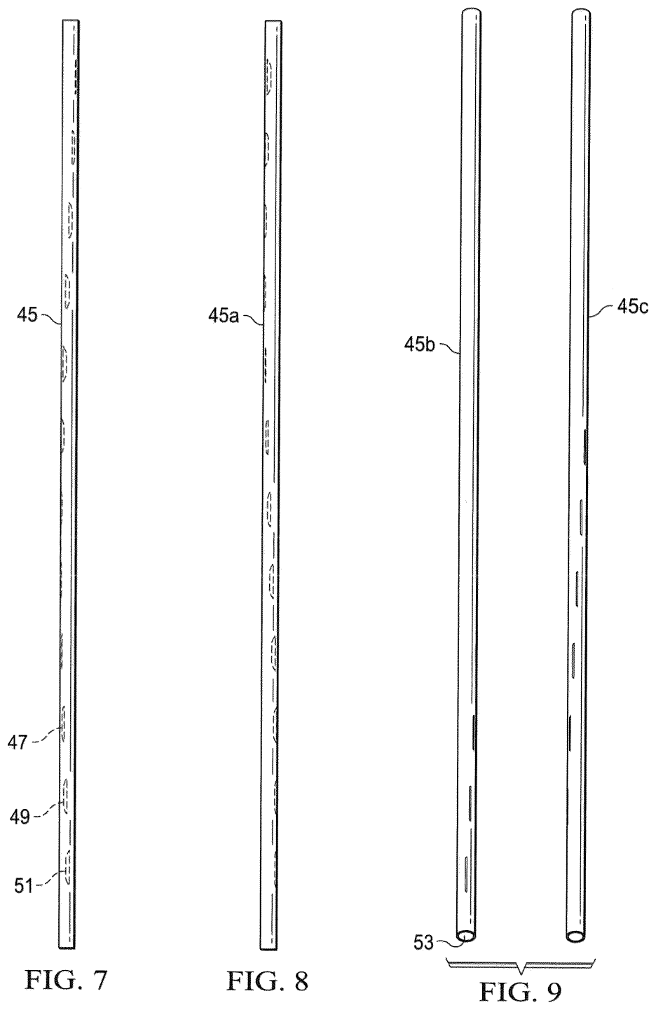

As can be seen in FIGS. 7-9, the pattern of slots which extends along the length of the spray bar 45 is spaced and arranged in a predetermined, tangential pattern so as to cause the spray bar 45 to rotate when pressurized, without the use of any mechanical drive mechanism. In the particular example shown in FIGS. 7-9, the slots are cut at a designed location set off the centerline of the diameter of the tubing. This offset is determined based on the specific filter tube size. Further, the spray tube is rotated a designed degree as each cut is made and advances along the length of the spray bar. The slot widths may vary in design dependent on the spray bar diameters required in various filtering applications.

As shown in FIG. 2, each spray bar has a top and bottom oppositely arranged extents and wherein the top extent is designed to be received within a bushing 53 provided as a part of a bearing support (55 in FIG. 4), the bushing allowing rotational movement of the spray bar 45 at the top extent thereof. The bearing support 55 also has an inlet passageway (57 in FIGS. 1, 4 and 4A) for communicating high pressure air and water to the interior of the spray bar 45. As shown in FIG. 4, the spray bar bottom extent is designed to be received on a synthetic bearing cup (generally at 59 in FIG. 4) to provide support for the lower extent of the spray bar 45. The bearing cup may be formed of a durable synthetic material, such as HDPE. In the preferred example shown, the spray bar lower extent rides on a ball bearing 61 within the synthetic bearing cup in use.

The described spray bar arrangement allows rapid rotation of each spray bar upon the application of high-pressure air or water within the interior of the spray bar. As has been described, each of the spray bars 45 has an internal bore which is in communication with a source of high-pressure air and high-pressure water for providing a brief pressure pulse of high-pressure air or water radially outward which causes the spray bar to rotate and spray air or water outwardly from the spay bar slots and through the interior sidewalls of the porous filter elements to dislodge the collected cake from the exterior wall surfaces during a cleaning step. The rotating spray bar subjects the cake of solids on the exterior sidewalls of the porous filter elements to a rapid discharge fluid flow axially directed from the filter element interiors outwardly through the sidewalls thereof in the absence of filtration through the vessel, so that the rapid axial fluid flow acts to flush the cake of solids off the exterior sidewall surfaces of the tubular filter elements and out a sludge discharge opening in the bottom of the vessel.

Because the spray bar is located inside the filter screen element, it is not subjected to the high solids environment on the outside of the filter screen. This is the “clean”, filtered side, meaning that this slotted tube will only encounter waste that has already gone through the filter mesh (i.e., the <20μ or <50μ mesh screen, or other size, depending upon the application). Thus, the only suspended solids that reach the spray bar have gone through the screen filter. As such, the slotted tube will not be prone to plugging, since it is not exposed to the high solids waste that accumulates on the outside of each filter screen element.

Because there are multiple filter screens per “bank” (six in the example shown), when each screen “purges” it not only blasts debris/scale off its own screen, but it also dislodges debris/scale from the adjacent screens, as well as from the inside of the screen bank housing itself. By purging all screens sequentially, it is possible to clean each screen from multiple angles, both from the inside (using its own spray bar), and also from the outside using each of the other spray bars. The slotted tube design is far more robust than individual spray “nozzles” of the kind used in other prior art systems, which could be prone to plugging or wear over time. In fact, even if one of the spray bars of the invention fails to rotate, the system will still operate. The spinning action of the spray bar improves the cleaning efficiency, but does not have to function for an otherwise successful system operation.

In one preferred form, a filtration process is provided comprising the steps of:
providing an inlet stream of a solid/fluid feed slurry to be filtered;
feeding the slurry into simultaneous engagement with the exterior porous sidewalls of each of a plurality of rigid screen type tubular filter elements at a pressure sufficient to attain surface filtration by the porous sidewalls of the filter elements, so that fluid of the slurry passes upwardly through the sidewalls of the tubular filter elements and solids within the slurry are collected on the exterior sidewall surfaces of the porous filter elements;
controlling the axial velocity of the feed slurry into the filter elements to form a controlled filter cake of solids on the porous exterior sidewalls of the tubular filter elements whereby the controlled filter cake of solids acts as a primary filter for the process, including regulating the radial flow velocity of the fluid and the radial differential pressure across the filter to selectively control the density of the cake of solids and regulating the axial flow velocity of the feed slurry to control the thickness of the cake of solids.

An invention has been provided with a number of advantages. The system is especially well adapted for treating produced well water which the water is used in an “on-the-fly” process and not intended for long term pit storage. In those situations, a simple and low-cost filtering step can be employed. The system of the invention can be operated unmanned and uses no chemicals. By eliminating the two current largest costs (manpower and chemical), treatment costs can be driven down by as much as 75% or more. The screen type filtration elements are virtually indestructible, designed for oil field service. Multiple screens can be employed in a filter bank, for high surface area. Filter elements of various micron sizes, e.g., 20 to 50μ, can be easily interchanged, depending upon the particular filter application.

Filtered water inside each element is reversed in order to purge accumulated solids. The system can be operated to provide the lowest backwash volume of any known self-cleaning filter system of this type, since the filter elements are only cleaned by backwash when plugged. By comparison, many of the existing SCS systems may have 10-25% waste volume in oilfield produced water service. The system of the invention will generally be well below 1% waste, a dramatic difference. The main reason for this dramatic difference is that existing SCS units continually clean a portion of their screen area and are therefore utilizing a lot of filtrate water continuously. The present system, on the other hand, intentionally operates in a “partially plugged” manner (that increases the level of filtration by using the built-up filter cake on the outside of the filter elements as a free form of “filter-aid”).

When the system of the invention is ready for a purge cycle, one screen bank is shut in and that single screen bank is completely cleaned, while; the other banks remain in service, thereby providing continuous filtration, even during a purge cycle. The purge (waste) volume is limited to the volume of the screen bank itself (plus the minimal wash water used), meaning that the waste stream is far more concentrated and far less volume than in traditional SCS systems. In a practical oilfield application, current SCS systems with high waste volumes are not economical, since there is so much waste generated.

Several other known SCS systems use mechanical contact for cleaning (i.e., brushes or wipers). The present system expressly avoids the use of mechanical contact and instead cleans using air/water pressure blasts without the need for mechanical wear components. Any system using brushes or wipers suffers from both increased maintenance and increased wear on the screen surface from abrasion.

As any wastewater with high scaling potential (e.g., high hardness in produced water) undergoes a pressure drop (i.e., through a valve, orifice or screen, or the like), scale tends to form at this location. The present system's air/water purge is designed to remove both the accumulated solids (debris), in addition to any accumulated water scale that may have developed on the surface of the filter screens.

The system is especially intended and designed to be used for oily, sticky sludge, such as that accompanying produced well water filtration operations. The system is closed to the atmosphere so that there is no open exposure to H2S, BTEX or other potentially harmful volatiles.

While the invention has been shown in only one of its forms, it will be appreciated that it is not thus limited, but is susceptible to various changes and modifications without departing from the spirit thereof.

What is claimed is:

1. A filter element for use in a filtration vessel for filtering water containing solids, the filter element comprising:
a rigid tubular screen type filter element having porous exterior and interior sidewalls, the interior sidewalls forming initially open interior axial bores, the filter elements being closed at a bottom end thereof and open at a top end thereof;
an elongated spray bar rotatably mounted for rapid rotation within the open interior axial bore of the tubular filter element, the spray bar having a plurality of slots cut along the length thereof in a predetermined axially offset, tangential pattern, the spray bar having an internal bore which is in communication with a source of high pressure air and high pressure water for providing a brief pressure pulse of high-pressure air or water radially outward which causes the spray bar to rotate and spray air or water outwardly from the spay bar slots and through the interior sidewall of the porous filter elements to dislodge any collected filter cake from the exterior sidewalls of the filter elements in use.

2. The filter element of claim 1, wherein the pattern of slots which extends along the length of the spray bar is spaced and arranged so as to cause the spray bar to rotate when pressurized, without the use of any mechanical drive mechanism.

3. The filter element of claim 2, wherein each spray bar has an open top extent and an oppositely arranged closed bottom extent and wherein the top extent is designed to be received within a bushing located in an opening provided in a tube sheet of a filtration vessel, the bushing allowing rotational movement of the spray bar at the top extent.

4. The filter element of claim 3, wherein the spray bar closed bottom extent is designed to be received on a bearing cup to provide support for the lower extent of the spray bar.

5. The filter element of claim 4, wherein the spray bar closed lower extent rides on a ball bearing within the bearing cup in use.

6. The filter element of claim 1, wherein the upper extent of the spray bar is connected by suitable fluid tubing to a high-pressure air and high-pressure water source.

7. A self-cleaning rigid screen type water filtration system for treating water containing solids, the system comprising:
a generally cylindrical filter vessel having a vessel interior which houses an elongated filter array comprising a plurality of rigid tubular screen type filter elements having porous exterior and interior sidewalls, the interior sidewalls forming interior axial bores, the filter elements being closed at a bottom end thereof and open at a top end thereof;
an unfiltered water inlet to the vessel for providing a feed stream of slurry water containing solids to be filtered;
wherein the unfiltered water is received in a bottom region of the vessel interior and travels upwardly where it contacts the exterior sidewalls of the filter elements at a sufficient pressure so that the fluid of the slurry passes inwardly through the sidewalls of the tubular filter elements, with a majority of the solids within the slurry being collected as a cake on the exterior sidewalls, without substantial intrusion into the interior axial bore of the filter elements;
an elongated spray bar rotatably mounted for rapid rotation within each of the filter elements, each of the spray bars having a plurality of slots cut along the length thereof in a predetermined pattern, the spray bars having an internal bore which is in communication with a source of high pressure air and high pressure water for providing a brief pressure pulse of high-pressure air or water radially outward, which causes the spray bar to rotate and spray air or water outwardly from the spay bar slots and through the interior sidewalls of the porous filter elements to dislodge the collected cake from the exterior wall surfaces.

8. The system of claim 7, wherein the rotating spray bar subjects the cake of solids on the exterior sidewalls of the porous filter elements to the rapid axially directed discharge flow, which acts to flush the cake of solids off the exterior sidewall surfaces of the tubular filter elements and out a sludge discharge opening in the bottom of the vessel.

9. The system of claim 8, wherein the fluid inlet and outlet to and from the vessel communicate with a source of pressure for temporarily reversing the flow of fluid though the interior of the vessel and recirculating filtered slurry through the sidewalls of the filter elements to dislodge a portion of the cake and to control the thickness thereof in a backwash operation.

10. The system of claim 9 wherein the filter array comprises a plurality of generally parallel filter tubes having open upper ends and closed lower ends, an upper plate interconnecting the upper ends of the tubular filter elements so that the bores thereof open upwardly of the upper plate into a top fluid chamber, and a lower plate interconnecting the closed lower ends thereof and forming part of a bottom fluid chamber, the system including a shell enclosing the array to form a filtrate chamber about the tubular filter elements between the upper and lower plates, the filtered fluid outlet being in fluid communication with the top chamber.

11. The system of claim 10, further comprising:
a discharge outlet at the bottom of the vessel including a normally closed valve for opening and closing off the discharge of sludge which is discharged downwardly into the bottom chamber of the vessel.

12. The system of claim 11, wherein the step of subjecting the cake of solids to the brief pressure pulse outwardly through the sidewalls of the filter elements is carried out after to backflushing the vessel interior.

13. The system of claim 12, wherein the steps of subjecting the cake of solids to the brief pressure pulse outwardly through the walls and axial discharge flow along the interior of the tubular filter elements are carried out within a time period of substantially less than one minute.

14. The system of claim 13, wherein the time period is on the order of 9 to 12 seconds.

15. A filtration process comprising the steps of:
providing an inlet stream of a solid/fluid feed slurry to be filtered;
feeding the slurry into simultaneous engagement with the exterior porous sidewalls of each of a plurality of rigid screen type tubular filter elements at a pressure sufficient to attain surface filtration by the porous sidewalls of the filter elements, so that fluid of the slurry passes upwardly through the sidewalls of the tubular filter elements and suspended solids within the slurry are collected on the exterior sidewall surfaces of the porous filter elements;
controlling the axial velocity of the feed slurry into the filter elements to form a controlled filter cake of solids on the porous exterior sidewalls of the tubular filter elements whereby the controlled filter cake of solids acts as an auxiliary filter aid for the process, including regulating the radial flow velocity of the fluid and the radial differential pressure across the filter to selectively control the density and thickness of the filter cake of solids which results.
